(19) United States
(12) Patent Application Publication
(10) Pub. No.: US 2011/0250115 A1
(43) Pub. Date: Oct. 13, 2011

(54) METHOD AND ABATEMENT DEVICE TO DESTROY LOW-CONCENTRATION COALMINE METHANE

(75) Inventors: Yiliang Chen, Shandong Province (CN); Xiaozhong Ma, Shandong Province (CN); Long Sun, Shandong Province (CN)

(73) Assignee: Shengli Oilfield Shengli Power Machinery Co., Ltd., Dongying City, Shangdong Province (CN)

(21) Appl. No.: 13/140,487

(22) PCT Filed: Sep. 5, 2009
(86) PCT No.: PCT/CN2009/073771

§ 371 Date: Jun. 17, 2011

(30) Foreign Application Priority Data
Dec. 17, 2008 (CN) 200810249601.0

(51) Int. Cl. B01D 53/72; G01N 1/00

(52) U.S. Cl. 423/245.1; 422/177; 422/173; 422/119

(57) ABSTRACT

A method and an abatement device for destroying the low concentration coalmine methane is disclosed. Low concentration coalmine methane can be destroyed automatically by passing through the device described in the following process: (A) Heating the oxidization bed electrically till its temperature rises up to at least 800° C.; (B) Passing the airflow that contains low concentration coalmine methane into the oxidization bed, where the methane is oxidized quickly, releasing thermal energy; (C) Reserving of the thermal energy generated to maintain the reactions continuously; (D) Discharging of waste gas from the oxidization bed after oxidizing reaction; (E) Reversing airflow direction and passing the low concentration coalmine methane from the opposite direction into the oxidization bed, where methane is oxidized and releasing the thermal energy; and (F) Reserving and outputting excess thermal energy. These steps from (B), (C), (D), (E) and (F) are repeated. The device is comprised of a reversal valve mechanism, oxidization bed, recovery mechanism, gas inlet system, as well as monitoring and measuring system. The reversal valve mechanism is mounted in the oxidization bed and attached to the recovery mechanism and the gas inlet system, which are assembled as a whole package. The invention is featured with energy saving, environmental protection, high efficiency, safety, prompt and complete reaction and it is applied in the engineering project of destroying low concentration coalmine methane or other similar projects.

### FIELD

The disclosure relates to the technology and facility for destroying the coalmine methane at low concentrations, in particular, a process and device to destroy the low-concentration coalmine methane.

### BACKGROUND

Presently, a kind of gas called “Ventilation Air Methane (VAM)” is produced during the coal production. Methane content is typically less than 1.5% in such vent air. There are few technical and economic processes for treating and utilizing VAM, so it is released to atmosphere generally. The research and demonstration for treatment and utilization of drained coalmine methane (or VAM) is based on the principle of Flow-Reversal Thermal Oxidization Reaction technology. However, because the concentration methane is low, energy consumption in the methane destruction process is comparatively high; also, because the molecular weight of methane is different from those of oxygen and nitrogen mixed in the air, the separation of methane from the air takes place quickly in the thermal field that has different temperature zones. The mixture of methane and air is not homogeneous and thermal oxidation reaction will not be continuous. This situation is typically evident in large-scale oxidization equipment. In high-gas coalmines, methane, carbon dioxide and other toxic gases are drained out of the coal seams by the gas drainage system above the ground. In some low-permeability coal seams, the drained coalmine gas contains methane only at low concentrations, less than 6% by volume, which is also essentially released to atmosphere. There is no economic and technical process available to treat or utilize this kind of methane currently. In some coalmines, even if methane is present in above 6%, because the coal bed gas contains a large amount of nitrogen and carbon dioxide, it still cannot be treated and utilized. Under such conditions, gas released to air causes environmental pollution and energy waste.

### SUMMARY

The purposes of this invention is to provide a process to destroy the low concentration methane contained in the coalmine ventilation air, by which a low quantity of methane is oxidized under high temperature environment, and thereby protect the environment and overcome the shortcomings of currently existing technologies.

The process of destroying low concentration methane, as disclosed in this application, is related to the application of a special device as well as the reaction including heating and oxidizing inside the device. The device for destroying low concentration coalmine methane, where such heating and oxidizing reaction is implemented through a special device as hereinbefore stated in this paragraph, operates automatically under the control of operation monitoring system whilst experiencing the following procedures: (A) Heating the oxidization bed electrically in the device to create the environment allowing methane oxidization reaction occurs, and till the temperature is higher than 800; (B) sending the airflow containing low concentration coalmine methane into the oxidization bed in which methane is oxidized quickly and releases thermal energy; (C) Storing the thermal energy generated in the heat retaining masses distributed in the device; (D) Discharging of the air out of the oxidization bed after oxidizing reactions; (E) Reversing airflow direction and sending the low concentration coalmine methane from the other direction into the oxidization bed where methane is oxidized, and releasing the thermal energy; (F) Retrieving and storing the excess produced heat. These steps (B), (C), (D), (E) and (F) are repeated continuously.

The vent air containing low concentration methane passes through the safety protection mechanism that comprises a dry flame arrestor, a wet flame arrestor, a fast cut-off valve and an electrical control mechanism.

An abatement device for destroying the low concentration coalmine methane comprises a reversal valve mechanism, an oxidization bed, a recovery mechanism, a gas inlet system as well as an operation monitoring and controlling system, wherein the switch valve mechanism as stated is mounted in the oxidization bed and attached to the recovery mechanism and the gas inlet system, which are assembled as a whole package.

The switch valve mechanism comprises an electromagnetic reversal valve, switch valve cylinders, a balance beam, a balance beam support, a switch valve, which are assembled in such sequence. The switch valve is connected to the gas inlet system, VAM inlet and exhaust outlet at its top and bottom side, respectively. The recovery valve mechanism comprises a recovery valve, a recovery valve piston connected to the piston and electromagnetic reversal valve. The recovery valve is arranged with exhaust air outlet, recovery air outlet and interface from which the recovery is jointed to the switch valve system. The air inlet system is comprised of a blower, a safety valve, a tube to sense VAM pressure after the blower, a pneumatic cut-off valve, a flow rate regulator, a fast cut-off valve, a dry flame arrestor, a wet flame arrestor and a manual valve, which are mounted in such sequence. The safety valve and pneumatic cut-off valve are connected to the VAM inlet. The manual valve is connected to the drained coalmine methane. The oxidization bed comprises a central located heater, heat retaining masses being distributed on the both sides of the heater, heat exchangers being mounted in the middle of the heat retaining masses, airflow balancers being arranged on both sides of the heat changers, heat insulation walls on the top and bottom of the oxidization box and VAM passage around the airflow balancer. The heater is located in the heat retaining masses, in which is symmetrical with respect to the heater. The operation measuring and monitoring system comprises a control unit, methane concentration sensors, a fast cut-off valve, a flow regulator, a safety valve, a blower, pressure sensors, temperature sensors, an airflow sensor, a recovery valve, a steam flow regulator, steam pressure sensors, steam temperature sensors, a switch valve, a water inlet and an oxidization bed. The methane concentration sensor, pressure sensor, temperature sensor and airflow sensor are mounted on one side where VAM inlet is arranged in the device to destroy the low concentration coalmine methane. The methane concentration sensor and temperature sensor for the exhaust air are on another side in the device where the exhaust outlet is arranged. The oxidization bed temperature sensor is inside the oxidization bed. The steam temperature sensor, steam pressure sensor and steam flow regulator are equipped at the steam outlet of the heating system. The drained coalmine methane concentration sensor, fast cut-off valve, flow regulator are installed beside the outlet for drained coalmine methane outlet.

The control unit calculates oxidization rate and the amount of methane destroyed based on data being measured by the sensors, which are installed in the control system. Upon the calculated oxidization rate reaches the defined value, the device implements to reverse the direction of VAM flow. The steam temperature sensor, steam pressure sensor, steam flow regulator are installed inside the oxidation heat recovery system. The data measured by the sensors of drained coalmine methane concentration and VAM concentration is referred to control the amount of drained coalmine methane mixed into the oxidization device or to function as a safety protection. If methane concentration mixed in the air exceeds the defined data after drained coalmine methane is mixed into the oxidization system, the control unit will adjust automatically the airflow regulator. In case the valve fails to adjust or the methane concentration in the coalmine and VAM rise unexpectedly above the defined value, the control unit sends out an order to close the safety valve and fast cut-off valve for protection.

Certain embodiments disclosed herein have the following advantages compared with currently existing technologies.

a. The mixture of coalmine VAM and drained coalmine methane is blown into the oxidization device by the blower. There is no need to pressurize the drained coalmine methane before mixture. The process features energy savings and easy operation.

b. Both mechanical control and electronic control are applied to prevent the drained coalmine methane flowing into the oxidizing device if coalmine VAM is not in the device before. This step avoids excessive high temperature or explosion in the oxidization device caused by the drained coalmine methane. This feature guarantees that the process is environment friendly with high efficiency.

c. Both dry flame arrestor and wet flame arrestor mounted on the drained coalmine methane pipelines will prevent the possible fire or spark getting into the drained coalmine methane pipelines to ensure safety and reliability in the drainage coalmine methane system.

### BRIEF DESCRIPTION OF THE DRAWINGS

FIGS. 1 and 2 show the schematic drawing of an abatement device structure in one example.

FIGS. 3 and 4 show the schematic drawing of the control system structure in one example.

### DETAILED DESCRIPTION

This disclosure discloses a method and an abatement device for destroying the low concentration coalmine methane. The low concentration coalmine methane can be destroyed automatically by being passed through a device that including heating and oxidizing the vent air containing low concentration methane, the processes are described as followings: (A) heating the oxidization bed electrically, creating a thermal condition for the methane to be oxidized, till its temperature rises up to 800° C.; (B) Sending the airflow that contains low concentration coalmine methane into the oxidization bed in which methane is oxidized quickly and thermal energy being released; (C) Reserving of the thermal energy generated and keeping the reactions continuously; (D) Discharging of the air out of the oxidization bed after oxidizing reaction. (E) Reversing airflow direction and sending the low concentration coalmine methane from the other direction into the oxidization bed where methane is oxidized and releasing the thermal energy; (F) Reserving enough thermal energy for the next reaction and transferring the excess thermal energy. These steps from (B) (C) (D) (E) to (F) are repeated continuously.

The low concentration coalmine methane passes through the safety protection mechanism consisting of a dry flame arrestor, a wet flame arrestor, a fast cut-off valve and an electric controller before it comes into the device.

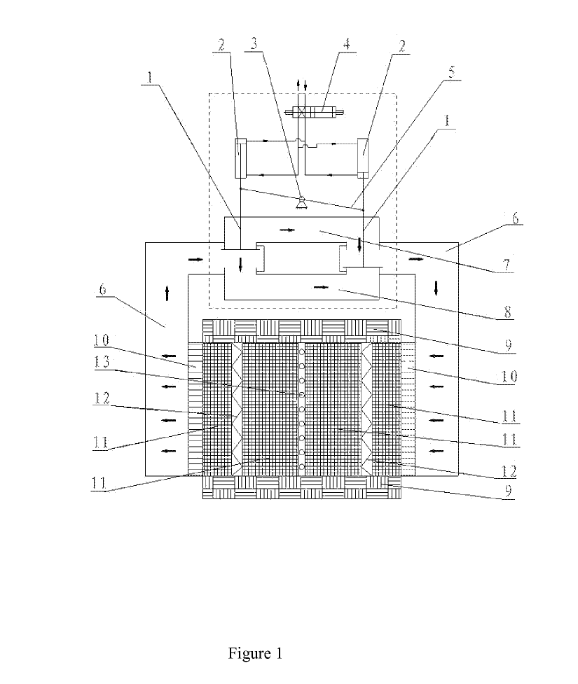

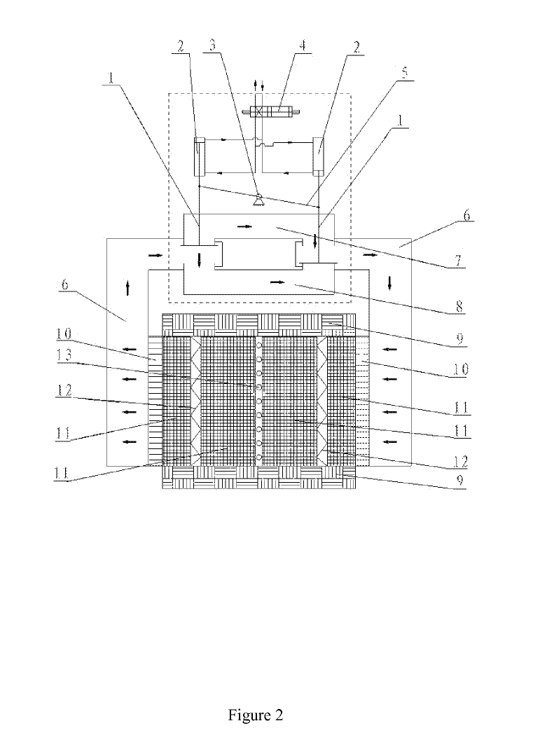

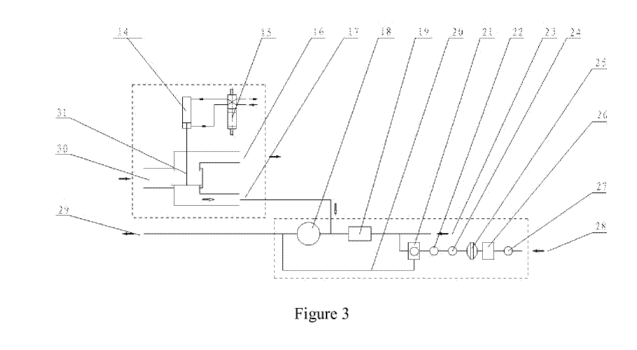

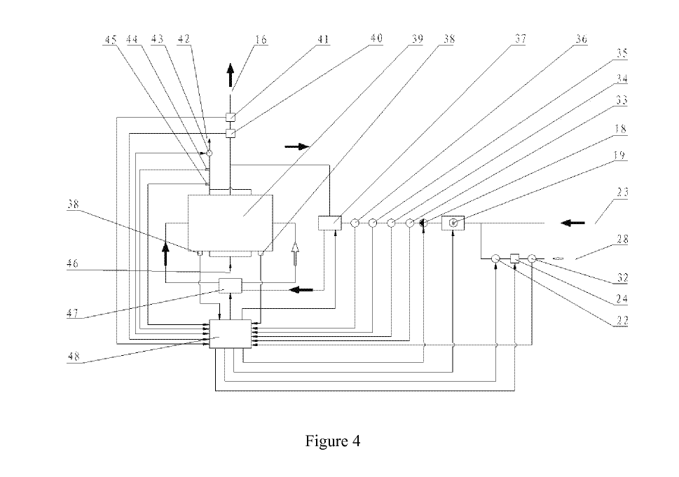

As shown in FIG. 1 through FIG. 3, an abatement device for destroying the low concentration coalmine methane includes a reversal valve mechanism, an oxidization bed, a recovery mechanism, an air inlet system as well as a monitoring and measuring system. The switch valve mechanism (47) as stated is mounted in the oxidization bed and attached to the recovery mechanism (37) and air inlet system, which are assembled as a whole package.

The reversal valve mechanism (47) comprises an electromagnetic reversal valve (4), switch valve cylinders (2), a balance beam (5), a balance beam support (3) and a switch valve (1), of which are assembled in such sequence. The switch valve (1) is connected to air inlet system and VAM inlet at its top and bottom ends. The recovery valve mechanism comprises an electromagnetic reversal valve (15) and a recovery valve (31), a recovery valve cylinders (14) connected to the mechanism. The recovery valve (31) is arranged with exhaust air outlet (16), recovery air outlet (17) and interface (30). The air inlet system is comprised of a blower (18), a safety valve (19), a tube (20) to sensor VAM pressure, a pneumatic cut-off valve (21), a flow rate regulator (22), a fast cut-off valve (24), a dry flame arrestor (25), a wet flame arrestor (26) and a manual valve (27), which are mounted in such sequence. The safety valve (19) and pneumatic cut-off valve (21) are connected to the VAM inlet (23). The manual valve (27) is connected to coalmine drained methane inlet (28). The oxidization bed comprises a central located heater (13), the heat retaining masses (11) being distributed on the both sides of the heater, the heat exchangers (12) being mounted between the heat retaining masses (11), the airflow balancer being (10) arranged on both sides of the heat changer, heat insulation walls (9) on the top and bottom of the oxidizing box and VAM passage (6) around the airflow balancer (10). The heat exchangers (12) are located in the heat retaining masses (11) that are symmetrical with respect to the heat exchangers (13). The operation measuring and monitoring system comprises a control unit (48), methane concentration sensors (32,33 and 40), a fast cut-off valve (24), a flow regulator (22), a safety valve (19), a blower (18), a pressure sensor (34), temperature sensors (35, 38 and 41), an airflow sensor (36), recovery valve (31), a steam flow regulator (43), steam pressure sensors (44), steam temperature sensors (45), switch valves (1), water inlet (46) and oxidization bed (39). The methane concentration sensor (33), pressure sensor (34), temperature sensor (35) and airflow sensor (36) are mounted on this bank (23) where VAM inlet is arranged in the device. The methane concentration sensor (40) and temperature sensor (41) for exhaust air are on that side in the device where the exhaust outlet (16) is arranged. The oxidization bed temperature sensor (38) is inside the oxidization bed (39). The steam temperature sensor (45), steam pressure sensor (44) and steam flow regulator 43 are equipped at the steam outlet (42) of the heating system. The drained coalmine methane concentration sensor (33), fast cut-off valve (24), flow regulator (22) are installed beside the drained coalmine methane outlet (28.)

In operation, the heater (13) in the oxidization bed (39) is initially charged with electricity to create a high temperature environment not less than 800° C. allowing oxidization reactions to occur. This stage is called “START-UP”, and then, the low concentration methane is blown into the high temperature oxidation bed by a blower through the switch valves (1). Methane contained in air is oxidized leaving heat energy to the heat heating masses (12) distributed on the other side of the airflow direction. Exhaust air after methane is destroyed is discharged out of the oxidization bed (39) through the switch valves (1). The reversal switch controlled by the operation measuring and monitoring system changes airflow to opposite direction after the previous step, meaning that VAM flows into the oxidization bed (39) through the exhaust outlet (8) of last cycle. Within first several seconds while reversal valve is shifting the airflow direction, the recovery valve (31) takes back the un-oxidized air containing methane in the last cycle left in VAM passage (6) and the oxidization bed (39). Then the recovery valve 31 closes and exhaust outlet 8 opens and the oxidized exhaust runs out of the oxidization bed (39). The low concentration methane is heated by the heat retaining masses (11) while passing through the oxidization bed (39). In the high temperature zone, the incoming low concentration methane is oxidized and thermal energy is released to the heat retaining masses (11) on the air outlet side of this cycle. After this cycle, the reversal valve changes air direction. By repeating these cycles, the low concentration methane is oxidized continuously without consuming extra energy. The thermal energy released from oxidization reactions has enough energy to heat and oxidize the incoming VAM for the next cycle. Furthermore, excess thermal energy can be collected through the built-in heat exchangers (12) and then be used for coalmine production, heating or power generation.

The control unit (48) is used to calculate oxidization rate and the amount of methane destroyed, as well as the base data to reverse the flow direction of VAM. The data measured by the sensors are referred to control the amount of drained coalmine to be mixed into the oxidizing device or for the purpose of safety protection. If methane concentration is excessive to the defined data after drained coalmine methane is mixed into the oxidizing system, the control unit will adjust automatically the flow regulator (22). In case the valve fails to adjust or the methane concentration from the coalmine, or VAM rises unexpectedly above the defined value, the control unit shut off the fast cut-off valve (24) by sending an order to the safety valve (19). In addition, the pneumatic cut-off valve (21) functions as a system protector, it will cut off drained coalmine methane supply into the oxidation device if the blower (18) stops. The measuring and monitoring system control the moment when switch valves (1) and recovery valve (31) open, and also communicates with other measuring system to implement multi-protection in the process of oxidizing.

If drained coalmine methane is needed to mix into VAM, the mixing activity is implemented through the coalmine methane flow regulator (22), methane mixing safety valve (19), blower (18), pneumatic cut-off valve (21), dry flame arrestor (25), wet flame arrestor (26), fast cut-off valve (24) and electronic control system.

The above specification, examples and data provide a complete description of the make and use of the invention. Since many embodiments of the invention can be made without departing from the spirit and scope of the invention, the invention resides in the claims hereinafter appended.

1. A method for destroying low concentration coalmine methane, comprising heating and oxidizing the low concentration coalmine methane with a dedicated device operating automatically through its measuring and controlling system, the process comprising: (A) heating the oxidation bed electrically at least to 800° C. to create a conditions for oxidation; (B) passing a coalmine gas containing low concentration of methane into the oxidization bed, in which methane is oxidized quickly and releases heat; (C) storing the released heat in a heat storage component of the device; (D) discharging of the gas out of the oxidization bed after the oxidizing reaction; (E) reversing the gas flow direction and passing the low concentration coalmine methane from an opposite direction into the oxidization bed where methane is oxidized and releasing the heat; and (F) storing the excess heat from the reactions and transferring the excess heat, wherein steps (B), (C), (D), (E) and (F) are repeated.

2. The method of claim 1 wherein airflow mixed with low concentration methane from coalmine is passed through a safety protection mechanism comprising a dry flame arrestor, a wet flame arrestor, a fast cut-off valve and an electrical controller before it flows into this device.

3. An abatement device for destroying low concentration coalmine methane, comprising a reversal valve mechanism, an oxidization bed, a recovery valve mechanism, a gas inlet system as well as the operation monitoring and controlling system, wherein the switch valve mechanism is mounted in the oxidization bed and attached to the recovery mechanism and the gas inlet system, which are assembled as a whole package.

4. The abatement device of claim 3, wherein the reversal valve mechanism comprises an electromagnetic reversal valve, switch valve cylinders, a balance beam, a balance beam support and a switch valve, which are assembled in sequence, wherein both ends are connected to the vent air inlet and exhaust air outlet respectively.

5. The abatement device of claim 3, wherein the recovery valve mechanism comprises a recovery valve, recovery valve cylinders, and an electromagnetic reversal valve, wherein the recovery valve has an exhaust air outlet, a recovery air outlet and a connector jointed with the switch valve system.

6. The abatement device of claim 3, wherein air inlet system comprises, mounted in such sequence, a blower, a safety valve, a tube that sensors the pressure of the vent air, a pneumatic controlled cut-off valve, a flow rate regulator, a fast cut-off valve, a dry flame arrestor, a wet flame arrestor and a manual valve, wherein the safety valve and pneumatic cut-off valve are connected to the vent air inlet and the manual valve is connected to the inlet of coalmine methane.

7. The abatement device of claim 1, wherein the oxidization bed comprises central located heaters, heat retaining masses being installed on the both sides of a heater, heat exchangers mounted between the heat retaining masses, and airflow balancers on both sides of the heat exchanger, the thermal insulation walls on the top and bottom of the oxidation box, and air passages around the airflow balancers.

8. The abatement device of claim 1, wherein the heat exchanger are arranged inside the heat retaining masses that are symmetric with respect to the heater.

9. The abatement device of claim 1, wherein the operation measuring and monitoring system comprises a control unit, methane concentration sensors, a fast cut-off valve, a flow regulator, a safety valve, a blower, a pressure sensor, temperature sensors, an airflow sensor, a recovery valve, a steam flow regulator, steam pressure sensors, steam temperature sensors, switch valve, water inlet and an oxidization bed.

10. The abatement device of claim 1, wherein the, hereinbefore, methane concentration sensor, pressure sensor, temperature sensor and airflow sensor are mounted on one side of this device, where the vent air inlet is arranged to connect the device, and then the methane concentration sensor for cleaned air, temperature sensor for cleaned air are on another side of this device where exhaust outlet is arranged, wherein the oxidization bed temperature sensor is inside the oxidization bed, wherein the steam temperature sensor, steam pressure sensor and steam flow regulator are mounted at the steam outlet of the heat recovering system, wherein the drained coalmine methane concentration sensor, fast cut-off valve, flow regulator are installed beside the outlet of coalmine methane.

11. The abatement device of claim 7, wherein the heat exchanger are arranged inside the heat retaining masses that are symmetric with respect to the heater.

12. The abatement device of claim 9, wherein the, hereinbefore, methane concentration sensor, pressure sensor, temperature sensor and airflow sensor are mounted on one side of this device, where the vent air inlet is arranged to connect the device, and then the methane concentration sensor for cleaned air, temperature sensor for cleaned air are on another side of this device where exhaust outlet is arranged, wherein the oxidization bed temperature sensor is inside the oxidization bed, wherein the steam temperature sensor, steam pressure sensor and steam flow regulator are mounted at the steam outlet of the heat recovering system, wherein the drained coalmine methane concentration sensor, fast cut-off valve, flow regulator are installed beside the outlet of coalmine methane.
